(19) United States
(12) Patent Application Publication
(10) Pub. No.: US 2025/0162441 A1
(43) Pub. Date: May 22, 2025

(54) ELECTRIC VEHICLE CHARGING POINT RECOMMENDATION SYSTEM

(71) Applicant: HERE GLOBAL B.V., EINDHOVEN (NL)

(72) Inventors: LAURI AARNE JOHANNES WIROLA, TAMPERE (FI); MIKKO BLOMQVIST, TAMPERE (FI)

(73) Assignee: HERE GLOBAL B.V., EINDHOVEN (NL)

(21) Appl. No.: 18/512,049

(22) Filed: Nov. 17, 2023

(51) Int. Cl. B60L 53/62; B60L 53/63; B60L 53/65; B60L 53/66; B60L 58/12; G06N 20/00

(52) U.S. Cl. CPC B60L 53/62; B60L 53/63; B60L 53/65; B60L 53/66; B60L 58/12; G06N 20/00; B60L 2240/62

(57) ABSTRACT

An apparatus configured to collect and predict charging data for an electric vehicle (EV) from a mobile device associated with a user or the EV or an infotainment unit of the EV.

### TECHNOLOGICAL FIELD

The field of the present disclosure relates to identifying locations for electric vehicle (EV) charging points, and more particularly, charging point recommendation for EVs.

### BACKGROUND

Electric vehicle (EV) adoption has become widespread and is predicted to continue to grow strongly in the upcoming years. EVs are generally efficient and emit fewer emissions while driving when compared to traditional vehicles with internal combustion engines (ICEs). However, the EV charging infrastructure available in most countries substantially lags compared to the petroleum fuel infrastructure and is struggling to keep pace with the EV adoption rate.

In some cases, the charging infrastructure features EV charging stations that have too few charging points for which there is too much demand. Other issues include broken chargers, high rates (cost), and confusion about how to pay as well as how long is needed to charge the EV. Moreover, there are multiple connector types and multiple charging speeds for some charging points.

A charging event for a given EV may also be dependent on vehicle characteristics (such as, but not limited to, a battery type, age of the battery, and remaining power of the battery) and external factors (such as, but not limited to, a temperature at the EV charging stations, and parallel usage of other chargers at the EV charging station). Such factors may make it difficult for a user of the EV to identify a suitable charging station for their charging needs.

### BRIEF SUMMARY

The system, apparatus, method, etc. of the present disclosure may crowd source data from the EVs or from mobile devices associated with the EVs, such as a mobile phone of the user associated with the EV. The apparatus may be configured to utilize real-time charging data and historical charging data related to the EV to identify and predict a charging profile of the EV. The charging profile may include information that may be utilized to generate recommendations for the most suitable charging points for the EV. Thus, the apparatus of the present disclosure may not depend on the charging point operators or data aggregators for data related to charging points.

According to some embodiments, an apparatus for charging point recommendation for the EV is provided. The apparatus comprises at least one processor and at least one memory including computer program code, the at least one memory and computer program code configured to, with the processor, cause the apparatus to at least collect real-time charging data for an electric vehicle (EV) from a mobile device associated with a user of the EV or an infotainment unit of the EV. The collected real-time charging data includes at least charging information for the EV and EV charge point information. The apparatus may be further caused to retrieve historical charging data associated with the EV from one or more databases. The apparatus may be further caused to generate a charging need prediction associated with the EV based on the collected real-time charging data, the retrieved historical charging data, and the EV charge point information. The generated charging need prediction may be associated with a charging profile of the EV. The apparatus may be further caused to store the generated charging need prediction in the one or more databases.

According to some example embodiments, the infotainment unit may be configured to communicate with a controller area network (CAN) bus of the EV to receive the real-time charging data for the EV.

According to some example embodiments, the collected real-time charging data may include at least one of location information associated with the EV, a temperature at a current location of the EV, a battery capacity of the EV, a current battery level of the EV, connection information associated with at least one charging port of the EV, an instantaneous charge rate of the EV, a range of the EV remaining at a current time instance, a current charging event associated with the location of the EV, and an occupancy information of a set of charging points associated with the location of the EV.

According to some example embodiments, the at least one processor may be further configured to determine an amount of time spent by the EV at the location of the EV. The at least one processor may further identify a location as a charging point based on a comparison of movement data of the mobile device associated with a user of the EV, EV location data, and one or more pre-stored charging locations.

According to some example embodiments, the at least one processor may be further configured to generate a charging profile associated with the EV based on specification data associated with the EV. The at least one processor may further store the generated charging profile in the one or more databases. The at least one processor may further utilize the stored charging profile to retrieve the historical charging data associated with the EV.

According to some example embodiments, the historical charging data includes at least one of compatible EV connector data, EV make or model data, EV model year or age data, or data associated with previous charging sessions of the EV.

According to some example embodiments, the at least one processor may be further configured to generate an output. The output may include at least one of a charging point recommendation, a predicted waiting time for the EV at one or more charging points, or a cost estimate for one or more charging points.

According to some example embodiments, the at least one processor may be further configured to provide, as an input, the collected real-time charging data and the retrieved historical charging data, to a machine learning (ML) model. The at least one processor may receive, as an output from the ML model, the charging need prediction for the EV.

According to some example embodiments, the output may be utilized to control of at least one of a vehicle navigation system, a vehicle control system, a vehicle electronic control unit, or an autonomous vehicle control system associated with the EV.

Some example embodiments disclosed herein provide a method for charging point recommendation for an EV. The method may include collecting real-time charging data for an EV from at least one of a mobile device associated with a user of the EV or an infotainment unit of the EV. The collected real-time charging data may include at least charging information for the EV and EV charge point information. The method may further include retrieving historical charging data associated with the EV from one or more databases. The method may further include generating a charging need prediction associated with the EV based on the collected real-time charging data, the retrieved historical charging data, and the EV charge point information. The generated charging need prediction may be associated with a charging profile of the EV. The method may further include storing the generated charging need prediction, as output, in the one or more databases.

According to some example embodiments, the infotainment unit may be configured to communicate with a controller area network (CAN) bus of the EV to receive the real-time charging data for the EV.

According to some example embodiments, the collected real-time charging data includes at least one of location information associated with the EV, a temperature at a current location of the EV, a battery capacity of the EV, a current battery level of the EV, connection information associated with at least one charging port of the EV, an instantaneous charge rate of the EV, a range of the EV remaining at a current time instance, a current charging event associated with the location of the EV, and an occupancy information of the EV charge point information associated with the location of the EV.

According to some example embodiments, the method may further include identifying a location as a charging point based on a comparison of movement data of at least one additional mobile device, EV location data, and one or more pre-stored charging locations.

According to some example embodiments, the method may further include generating a charging profile associated with the EV based on specification data associated with the EV. The method may further include storing the generated charging profile in the one or more databases. The method may further include utilizing the stored charging profile to retrieve the historical charging data associated with the EV.

According to some example embodiments, the historical charging data may include at least one of compatible EV connector data, EV make or model data, EV model year or age data, or data associated with previous charging sessions of the EV.

According to some example embodiments, the method may further include generating an output based on the charging need prediction. The output may include at least one of a charging point recommendation, a predicted waiting time for the EV at one or more charging points, or a cost estimate for one or more charging points.

According to some example embodiments, the method may further include providing, as an input, the collected real-time charging data and the retrieved historical charging data, to a machine learning (ML) model. The method may further include receiving, as an output from the ML model, the charging need prediction for the EV.

According to some example embodiments, the output may be utilized for controlling at least one of a vehicle navigation system, a vehicle control system, a vehicle electronic control unit, or an autonomous vehicle control system.

According to some example embodiments, the output from the ML model may be a charging need prediction for at least one additional EV, wherein the at least one additional EV has a similar charging profile.

According to some example embodiments, the at least one additional EV similar charging profile includes a similar EV make or model, model year or age, or similar historical charging data.

Some example embodiments disclosed herein provide a computer programmable product comprising a non-transitory computer-readable medium having stored thereon computer-executable instruction which when executed by one or more processors, cause the one or more processors to carry out operations for charging point recommendation for the EV. The operations may include collecting real-time charging data for an EV from at least one of a mobile device associated with a user of the EV or an infotainment unit of the EV. The collected real-time charging data includes at least charging information for the EV and EV charge point information. The operations may further include retrieving historical charging data associated with the EV from one or more databases. The operations may further include generating a charging need prediction associated with the EV based on the collected real-time charging data, the retrieved historical charging data, and the EV charge point information. The generated charging need prediction may be associated with a charging profile of the EV. The operations may further include storing the generated charging need prediction in the one or more databases.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a diagram of a charging point recommendation system, in accordance with an example embodiment;

FIG. 2A illustrates a diagram of an apparatus for charging point recommendation, in accordance with an example embodiment;

FIG. 2B illustrates a diagram depicting communication of a map and positioning engine (MPE) with an infotainment unit of the EV, in accordance with one or more example embodiments;

FIG. 3 illustrates a diagram depicting steps for charging point recommendation for the EV, in accordance with an example embodiment; and

FIG. 4 illustrates a flow chart of a method for charging point recommendation for the EV, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer-readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing devices.

As defined herein, a “computer-readable storage medium,” which refers to a non-transitory physical storage medium (for example, a volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no limiting effect.

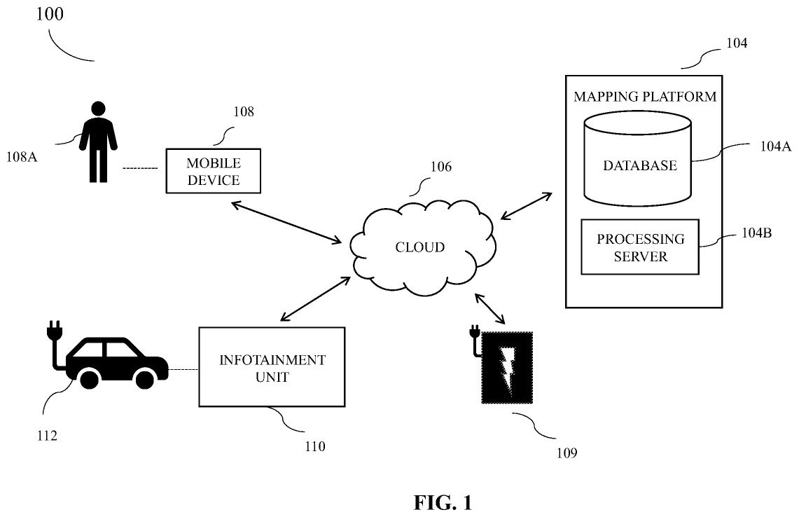

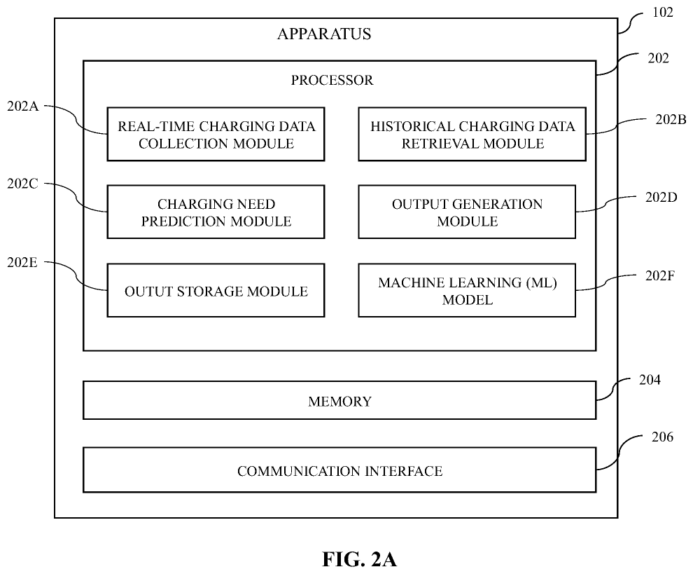

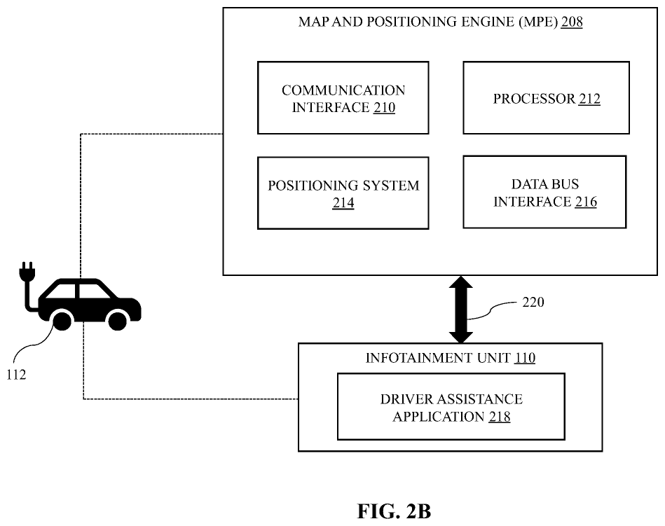

FIG. 1 provides an illustration of an example system 100 that can be used in conjunction with various embodiments of the present invention. As shown in FIG. 1, the system 100 may include an apparatus 102 (see FIG. 2) and a mapping platform 104 as well as end user devices, etc.

The apparatus 102 may be a stand-alone computer or a part of the other components listed in this application (e.g., smartphones, tablets, vehicle infotainment systems, etc.)

The mapping platform 104 may further include one or more databases 104A and a processing server 104B. The system 100 may further include a cloud 106 (e.g., a vehicle OEM or service provider hosted cloud), a mobile device 108 associated with a user 108A, an infotainment unit 110 of an electric vehicle (EV) 112, and a network 114. The components described in the system 100 may be further broken down into more than one component such as one or more sensors or applications of the mobile device 108 or EV 112 and/or combined in any suitable arrangement. Further, it is possible that one or more components of the system 100 may be rearranged, changed, added, and/or removed.

In an example embodiment the system 100 may be embodied as or associated with a cloud-based service or a cloud-based platform. In each of such embodiments, the apparatus 102 may be communicatively coupled to the components shown in FIG. 1 to carry out the desired operations and wherever required modifications may be possible within the scope of the present disclosure. As mentioned above the apparatus 102 may be implemented within an EV 112. The EV 112 may be an autonomous electric vehicle, a semi-autonomous electric vehicle, or a manually driven electric vehicle. The infotainment unit 110 may also be integrated with the EV 112. The infotainment unit 110 may be utilized by the user 108A to access various applications, such as navigation applications, entertainment applications, and so forth. Further, in one embodiment, the apparatus 102 may be a standalone unit configured to generate a charging need prediction and further recommend one or more charging points to the user 108A for charging the EV 112. In an embodiment, the user 108A may be a driver or a passenger of the EV 112. Alternatively, the apparatus 102 may be embodied within an external device such as the EV 112 or the mobile device 108. Additionally, the mobile device 108 may be associated, coupled, or otherwise integrated within the EV 112, such as within the EV's head unit, infotainment unit, or an advanced driver assistance system (ADAS). All of the functionalities may be run upon one device such as an EV, mobile device, etc. or utilize multiple of these devices for a distributed solution.

In some example embodiments, the apparatus 102 may be any user-accessible device such as a mobile phone, a smartphone, a portable computer, and the like that are portable themselves or as a part of another portable/mobile object such as the EV 112. The apparatus 102 may comprise a processor, a memory, and a communication interface. The processor, the memory, and the communication interface may be communicatively coupled to each other. In some example embodiments, the apparatus 102 may be associated, coupled, or otherwise integrated with the EV 112 of the user 108A, such as an advanced driver assistance system (ADAS), a personal navigation device (PND), a portable navigation device, infotainment unit 110 and/or other device that may be configured to provide route guidance and navigation related functions to the user 108A. In such example embodiments, the apparatus 102 may comprise a processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the apparatus 102. Additional, different, or fewer components may be provided. For example, the apparatus 102 may be configured to execute and run mobile applications such as a messaging application, a browser application, a navigation application, and the like.

In some other embodiments, the system 100 may feature an apparatus 102 that may communicate with or, in some cases, be part of a cloud computing solution such as a hosted cloud (cloud 106). The cloud 106 may be configured to anonymize data received from the apparatus 102, as needed before using the data for further processing. In some embodiments, anonymization of data may also be done by the mapping platform 104. In some embodiments, the cloud 106 may include a server and a database configured to receive various forms of probe data from vehicles or devices. These servers and databases may be the same utilized by the mapping platform 104 or separate pieces of infrastructure.

The probe data may be used by the system 100 to generate and predict charging need information for a given EV. Such data may be supplied or supplemented by data from a mobile device to generate independent location-based services or other entities may participate and contribute in the same manner as described herein.

The system 100 may provide aggregated mobility data from a plurality of probes or devices associated with a respective EV or charge point. The system may use this data for predicting EV charge point utilization. For example, the system may provide probe data points including location (e.g., latitude and longitude or a map-matched location) and a charge level or available battery range of a vehicle. Such information can provide insight into locations where vehicles are substantially depleted on battery charge as described further below.

The system 100 may further provide charge status information for individual vehicles. Battery charge level (e.g., at the start and at the end of charging) can be used to determine what charge needs a vehicle may have, how long it may need to charge, and what data might be obtained from a charge point. Charge point utilization prediction as described herein is used to help predict amongst other things, the monetary value of a given charge point or the potential value of placing a new charge point, moving an existing point, etc.

In FIG. 1, a charge point 109 is shown. This point may represent any public or private charge point. The amount of energy provided by this point 109 may vary over time (even with a single vehicle). Different amounts of energy may be delivered to a vehicle depending on the capacity of the battery, etc. For example, charging speed and the amount of energy provided to a vehicle may decrease when a battery is nearing capacity (e.g., above 80% full capacity).

Information pertaining to EVs which may be received from an OEM, other service providers, etc. may include vehicle specifics, such as battery capacity, charging type (e.g., connector, charge compatibility), etc. EV information can also include sensor data, which can include trajectory information (e.g. an origin and destination), a battery charge level at the beginning and end of a trajectory or drive, home charging events (e.g., including duration, energy delivered, time, battery levels), parking events, etc.

According to some embodiments, other data utilized by the system 100 and/or the apparatus 102 may include data from a charge point service provider or a charge point information service. Charge point service providers (e.g., a power company) or a charge point information service (e.g., a charge point finder application) can be sources of rich data that can inform on charge point utilization, state-of-charge of vehicles that use the charge points, historical charge point information (e.g., price, utilization, daily/weekly/seasonal fluctuations, etc.), and other information associated with charge points that can be used to train a machine learning model capable of predicting charge point utilization at a candidate location. The sharing of such information is shown in FIG. 1, wherein the charge point 109 is also shown sharing information with the cloud 106.

It is fully envisioned that in some cases the charge point operator may not share some or all of the charging information data collected by the charge point 109. In such a situation, data from an end user mobile device 108 or data from the infotainment unit 110 of an EV 112 may be leveraged in combination with or as part of probe data and/or crowdsourced data provided to the system 100. This data may then be used to determine or predict charging infrastructure utilization and availability. In this example, the data from the mobile device 108, charge point 109, and infotainment system 110 are made available to the mapping platform 104.

The mapping platform 104 may comprise the one or more databases 104A for storing map data and the processing server 104B. The one or more databases 104A may include data associated with one or more of a road signs, road condition information, speed signs, or road objects on a link or path. Further, the one or more databases 104A may store charging data, accident data, node data, road segment data, link data, point of interest (POI) data, link identification information, heading value records, or the like. Also, the one or more databases 104A further include speed limit data of each lane, cartographic data, routing data, and/or maneuvering data. Additionally, the one or more databases 104A may be updated dynamically to accumulate real-time traffic conditions based on prediction of vehicle charging needs.

The real-time traffic conditions may be collected by analyzing the location transmitted to the mapping platform 104 by a one or more (or a large number) of users. In one example, by calculating the speed of the road users along a length of road, the mapping platform 104 may generate a live traffic map, which is stored in the one or more databases 104A in the form of real-time traffic conditions based on prediction of vehicle charging needs. In one embodiment, the one or more databases 104A may further store historical traffic data that includes travel times, areas where charging issues are prone to occur, areas with the minimum and maximum charging needs, average speeds and probe counts on each road or area at any given time of the day and any day of the year.

According to some example embodiments, the road segment data records may be links or segments representing roads, streets, or paths, as may be used in calculating a route or recorded route information for determination of one or more personalized routes to enable optimized charging on an EV. The node data may be ending points corresponding to the respective links or segments of road segment data. The road link data and the node data may represent a road network used by vehicles such as cars, trucks, buses, motorcycles, and/or other entities. Optionally, the one or more databases 104A may contain path segment and node data records, such as shape points or other data that may represent pedestrian paths, links, or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as charging stations, hotels, restaurants, museums, stadiums, offices, parking lots, auto repair shops, buildings, stores, parks, etc.

The one or more databases 104A may also store data about the POIs and their respective locations in the POI records. The one or more databases 104A may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the one or more databases 104A may include event data (e.g., traffic incidents, construction activities, scheduled events, unscheduled events, vehicle accidents, diversions, etc.) associated with the POI data records or other records of the one or more databases 104A associated with the mapping platform 104. Optionally, the one or more databases 104A may contain path segment and node data records or other data that may represent pedestrian paths or areas in addition to or instead of the autonomous vehicle road record data. In an embodiment, one or more databases 104A may be a source-available document-oriented database. The POI records may also contain an indicator that a given POI does or does not have a charging station.

In some embodiments, the one or more databases 104A may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end-user navigation devices or systems.

For example, geographic data may be compiled (such as into a platform specification format (PSF) format) to organize and/or configure the data for performing navigation-related functions and/or services in an event of a predicted vehicle's charging needs, such as route calculation, route guidance, map display, speed calculation, distance and travel time functions, and other functions, by a navigation device, such as by the apparatus 102 or by the mobile device 108. The navigation-related functions may correspond to vehicle navigation, pedestrian navigation, or other types of navigation to avoid a zone where the vehicle accident has been predicted by the apparatus 102. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the one or more databases 104A may be a master geographic database, but in alternate embodiments, the one or more databases 104A may be embodied as a client-side map database and may represent a compiled navigation database that may be used in the apparatus 102 to provide navigation and/or map-related functions in an event of a predicted vehicle's charging event or needs. For example, the one or more databases 104A may be used with the apparatus 102 to provide an end user with navigation features. In such a case, the one or more databases 104A may be downloaded or stored locally (cached) on the apparatus 102. As mentioned above, the apparatus 102 may be contained within a smartphone or in-car navigation system allowing users to access the system 100 on the go.

The processing server 104B may comprise processing means, and communication means. For example, the processing means may comprise one or more processors configured to process requests received from the apparatus 102. The processing means may fetch map data from the one or more databases 104A and transmit the same to the apparatus 102 via the cloud 106 in a format suitable for use by the apparatus 102. In one or more example embodiments, the mapping platform 104 may periodically communicate with the apparatus 102 via the processing server 104B to update a local cache of the map data stored on the apparatus 102. Accordingly, in some example embodiments, the map data may also be stored on the apparatus 102 and may be updated based on periodic communication with the mapping platform 104. In some embodiments, the map data may also be stored on the mobile device 108 and may be updated based on periodic communication with the mapping platform 104 including the processing server 104.

The processing server 104B may receive probe data, directly or indirectly, from a mobile device 108, such as when the mapping platform 104 is also functioning as, or part of, the cloud 106.

The mobile device 108 may include one or more detectors or sensors that act as a positioning system built or embedded into or within the device. Alternatively, the mobile device 108 may use communications signals for position determination. The mobile device 108 may receive location data from a positioning system, such as a Global Navigation Satellite System (GNSS) like the global positioning system (GPS) Galileo, etc., cellular tower location methods, access point communication fingerprinting, or the like. The processing server 104B, either directly or indirectly, may receive sensor data configured to describe a position of a mobile device, or a controller of the mobile device 108 may receive the sensor data from the positioning system of the mobile device 108. The mobile device 108 may also include a system for tracking mobile device movement, such as rotation, velocity, or acceleration. Movement information may also be determined using the positioning system. The mobile device 108 may use the detectors and sensors to provide data indicating a location of a vehicle. This vehicle data, also referred to herein as part of the probe data, may be collected by any device capable of determining the necessary information, and providing the necessary information to a remote entity. The mobile device 108 is one example of a device that can function as a probe to collect probe data of a vehicle.

More specifically, probe data (e.g., collected by mobile device 108) may be representative of the location of a vehicle at a respective point in time and may be collected while a vehicle is traveling along a route, at the origin of the route, a destination, or waypoints along the route. Probe data of some example embodiments may include charge status of a vehicle. According to the example embodiment described below with the probe data being related to a motorized vehicle traveling along roadways, the probe data may include, without limitation, location data, (e.g. a latitudinal, longitudinal position, and/or height, GNSS coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The mobile device 108, may be any device capable of collecting the aforementioned probe data. Some examples of the mobile device 108 may include specialized vehicle mapping equipment, navigational systems, mobile devices such as phones or tablets, or the like.

Further, this probe data may include battery charge level or other contextual information about a source of the probe data that may provide inputs to the mapping platform 104 for establishing where an EV charge point would be most beneficial and where such an EV charge point would provide the greatest ROI. This data may be collected by mobile device 108 by tracking EV movement over time via device accelerometer, etc. to estimate how much battery has been used since the last charge.

For example, the mobile device may infer a charge has occurred by the lack of movement of a mobile device located within an EV. The mobile device (acting as or part of the system 100) may automatically or manually detect movement above a certain threshold (e.g., 30 mph) as an indication that the mobile device is being driven within a vehicle. Using the map data mentioned above and specifically the data which indicates the location of charge point 109, the system 100 may deduce that an EV has driven to a charge point and is parked close to said charge point either charging or waiting to charge.

In some example embodiments, the mobile device 108 may be any user-accessible device such as a mobile phone, a smartphone, tablet, a portable computer, and the like associated with the user 108A. The mobile device 108 may comprise a processor, a memory, and a communication interface. The processor, the memory and the communication interface may be communicatively coupled to each other. In some example embodiments, the mobile device 108 may be associated, coupled, or otherwise integrated with the EV 112 of the user 108A, such as an advanced driver assistance system (ADAS), a personal navigation device (PND), a portable navigation device, the infotainment unit 110 and/or other device that may be configured to provide route guidance and navigation related functions to the user 108A. In such example embodiments, the mobile device 108 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the mobile device 108. Additional, different, or fewer components may be provided. In one embodiment, the mobile device 108 may be directly coupled to the apparatus 102 via a communications network. In some example embodiments, at least one user equipment such as the mobile device 108 may be coupled to the apparatus 102 via the cloud 106 and one or more communications networks. For example, the apparatus 102 may be part of a consumer electric vehicle or an end user device. In some example embodiments, the mobile device 108 may serve the dual purpose of a data gatherer and a beneficiary device. This is also true of the vehicle infotainment unit 110. The mobile device 108 and/or infotainment unit may be configured to capture the sensor data associated with a road on which the EV 112 may be traversing. The sensor data may for example be image data of road objects, road signs, charge points, or the surroundings. The sensor data may refer to sensor data collected from a sensor unit in the mobile device 108. In accordance with an embodiment, the sensor data may refer to the data captured by any vehicle using sensors. The mobile device 108 may be communicatively coupled to the apparatus 102, the mapping platform 104, the infotainment unit 110 and the cloud 106 over a network.

The network may be wired, wireless, or any combination of wired and wireless communication networks, such as cellular, Wi-Fi, internet, local area networks, or the like. In one embodiment, the network may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. For example, the mapping platform 104 may be integrated into a single platform to provide a suite of mapping and navigation-related applications for OEM devices, such as the user devices and the apparatus 102. The apparatus 102 may be configured to communicate with the mapping platform 104 over the network. Thus, the mapping platform 104 may enable the provision of cloud-based services for the apparatus 102. Personal area networks such as Bluetooth, IrDA, ZigBee, etc. may also be utilized in some embodiments.

In operation, the EV 112 may require charging at some point. In such a case, the apparatus 102 may recognize the charge need. In an example embodiment, the mobile device 108 or the infotainment unit 110 may be utilized by the user 108A to transmit a trigger to the apparatus 102, to receive the recommendation for one or more charging points to charge the EV 112. Based on the recognition of the charge need, the apparatus 102 may be configured to collect real-time charging data for the EV 112 from the infotainment unit 110 of the EV 112 or the mobile device.

In some embodiments the infotainment unit 110 may be connected to the mobile device 108. When the communication between the mobile device 108 and the infotainment unit 110 is absent, the apparatus 102 may collect the real-time charging data for the EV 112 from the mobile device 108 and/or infotainment unit independently. It is fully envisioned that in some cases the system 100 may function only on mobile device data or infotainment system data (and not both). The collected real-time charging data may include at least information for the EV 112 and EV charge point 109 information. The EV charge point information may include information associated with one or more charging points that may be recommended by the apparatus 102. It should be noted that the infotainment unit may be configured to communicate with a controller area network (CAN) bus of the EV to receive the real-time charging data for the EV and information on a given charge point.

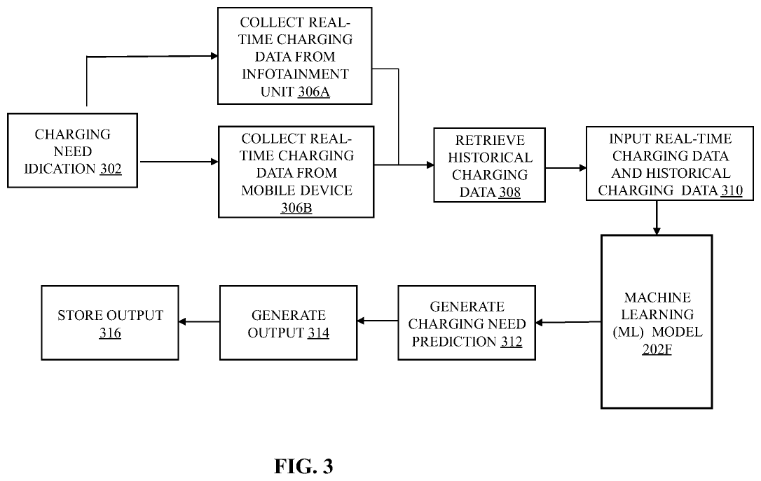

In an embodiment, the collected real-time charging data may include at least one of: location information associated with the EV 112, a temperature at a current location of the EV 112, a battery capacity of the EV 112, a current battery level of the EV 112, connection information associated with at least one charging port of the EV 112, an instantaneous charge rate of the EV 112, a range of the EV 112 remaining at a current time instance, a current charging event associated with the location of the EV 112, and an occupancy information of the charging points associated with the location of the EV 112. Details of collection of the real-time charging data are further provided, for example, in FIG. 3.

The apparatus 102 may further retrieve historical charging data associated with the EV 112 from the one or more databases 104A. The historical charging data may include compatible EV connector data, EV make or model data, EV model year or age data, or data associated with previous charging sessions of the EV. In an embodiment, the historical charging data may be retrieved by utilizing a charging profile of the EV 112 that may be generated by the apparatus 102 and stored in the one or more databases 104A. Details of retrieval of the historical charging data are further provided, for example, in FIG. 3.

The apparatus 102 may further generate a charging need prediction associated with the EV 112 based on the collected real-time charging data, the retrieved historical charging data, and the EV charge point information. The generated charging need prediction may be associated with the charging profile of the EV 112. In some embodiments, the apparatus 102 may utilize a machine learning (ML) model to generate the charging need prediction associated with the EV 112. Details of the ML model are further provided, for example, in FIG. 3.

The apparatus 102 may be further configured to store the generated charging need prediction in the one or more databases 104A. In an embodiment, the generated charging need prediction may include data such as an average charging speed of the EV 112, a maximum charging speed of the EV 112, a charging curve of a battery of the EV 112, a waiting time for charging at one or more charging points of a set of charging points, and so forth. In some embodiments, the apparatus 102 may be configured to generate an output based on the charging need prediction associated with the EV 112. The output may include the recommendations for the one or more charging points 109, a predicted waiting time for the EV 112 at each of the one or more charging points 109, and a monetary cost associated with utilizing the one or more charging points 109. Details of the output are further provided, for example, in FIG. 3.

FIG. 2A illustrates an apparatus 102 for charging point recommendation for the EV 112, in accordance with an example embodiment. FIG. 2A is explained in conjunction with elements of FIG. 1. The apparatus 102 may include a processing means such as at least one processor 202 (hereinafter, also referred to as “processor 202”), storage means such as at least one memory 204 (hereinafter, also referred to as “memory 204”), and a communication means such as at least one communication interface 206 (hereinafter, also referred to as “communication interface 206”). The processor 202 may further include one or more processing modules, such as a real-time charging data collection module 202A, a historical charging data retrieval module 202B, a charging need prediction module 202C, an output generation module 202D, an output storage module 202E and an ML model 202F. The processor 202 may retrieve computer program code instructions that may be stored in the memory 204 for execution of the computer program code instructions.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading.

In some embodiments, the processor 202 may be configured to provide Internet-of-Things (IoT) related capabilities to the user 108A of the apparatus 102. The IoT related capabilities may in turn be used to provide charging station recommendation solutions, smart navigation solutions, and hazard warnings by providing real-time updates to the users to take pro-active decision on turn-maneuvers, lane changes, overtaking, merging, and the like, big data analysis, and sensor-based data collection by using the cloud-based mapping system for providing navigation recommendation services to the users. The apparatus 102 may be accessed using the communication interface 206. The communication interface 206 may provide an interface for accessing various features and data stored in the apparatus 102.

Additionally, or alternatively, the processor 202 may include one or more processors capable of processing large volumes of workloads and operations to provide support for big data analysis. In an example embodiment, the processor 202 may be in communication with the memory 204 via a bus for passing information among components coupled to the apparatus 102.

The real-time charging data collection module 202A may be configured to collect the real-time charging data for the EV 112 from the mobile device 108 or the infotainment unit 110.

In an embodiment, the mobile device 108 may be separate from the EV 112. In that scenario, the mobile device 108 may be an additional mobile device that serves as a crowdsourcing contributor device for providing data to the mapping platform 104 about a corresponding charge point. However, when the mobile device 108 is coupled to the EV 112, then it helps to collect real-time charging data for the EV 112.

The collected real-time charging data may include at least charging information for the EV 112 and EV charge point 109 information. For example, the real-time charging data collection module 202A may communicate with the mobile device 108 or the infotainment unit 110 in real-time or near real-time via the network 114 to collect the real-time charging data for the EV 112. Details of collection of the real-time charging data are further provided, for example, in FIG. 3.

The historical charging data retrieval module 202B may be configured to retrieve the historical charging data associated with the EV 112 from the one or more databases 104A. For example, the historical charging data retrieval module 202B may communicate with the one or more databases 104A via the network 114 to retrieve the charging profile of the EV 112. The charging profile of the EV 112 may include the historical charging data associated with the EV 112. Details of retrieval of the historical charging data are further provided, for example, in FIG. 3.

The charging need prediction module 202C may be configured to generate the charging need prediction associated with the EV 112 based on the collected real-time charging data, the retrieved historical charging data, and the EV charge point information. The charging need refers to the requirement for charging the EV 112 due to battery or charge depletion and correspondingly identification of the best available charging point based on the charging profile, etc. of the EV 112. The prediction of the charging need is done by the use of the ML model 202F that is previously trained on stored or historical charging profiles of numerous EVs and is able to output a label indicating a prediction output, such charging required or charging not required. The generated charging need prediction may be associated with the charging profile of the EV 112. For example, the charging need prediction module 202C may be configured to process the collected real-time charging data and the retrieved historical charging data to generate the charging need prediction associated with the EV 112. Details of the generation of the charging need prediction further provided, for example, in FIG. 3.

The output generation module 202D may be configured to generate an output based on the charging need prediction associated with the EV 112. The output may be associated with one or more charging points for the EV 112. For example, the output generation module 202D may process the charging need prediction to generate the output for the user 108A. The output may be associated with the recommendations related to one or more charging points. For example, the processor may generate an alert message on a display interface of the apparatus 102 or the mobile device 108 that the EV battery is depleted, charging needed soon, etc. Further, the display interface may also display a map and show location of the most suitable charge point(s) in vicinity of the EV 112. It should be noted that the most suitable charge point may, in some embodiments, be the cheapest charge point to use, fastest, located close to certain POIs, etc. Details of the generation of the output are further provided, for example, in FIG. 3.

The output storage module 202E may be configured to store the charging need prediction or the output in the one or more databases 104A. For example, the output storage module 202E may communicate with the one or more databases 104A via the network 114 to transmit the charging need prediction or the output to the one or more databases 104A. Details of storage of the output are further provided, for example, in FIG. 3.

The ML model 202F may be configured to generate the charging need prediction. In some embodiments, the ML model 202F may receive the collected real-time charging data and the retrieved historical charging data. Based on the collected real-time charging data and the retrieved historical charging data, the ML model 202F may generate the charging need prediction. Details of usage of the ML model 202F are further provided, for example, in FIG. 3.

In some embodiments, the ML model 202F is embodied outside the processor 202, and the representation shown in FIG. 2A is for exemplary purposes only. The ML model 202F may provide the necessary intelligence needed by the apparatus 102 for generation of the charging need prediction.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus to carry out various functions in accordance with an example embodiment of the present invention. For example, the memory 204 may be configured to buffer input data for processing by the processor 202. As exemplarily illustrated in FIG. 2A, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present invention while configured accordingly. Thus, for example, when the processor 202 is embodied as an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202.

The communication interface 206 may comprise input interface and output interface for supporting communications to and from the apparatus 102 or any other component with which the apparatus 102 may communicate. The communication interface 206 may be any means such as a device or circuitry embodied in either hardware or a combination of hardware and software that is configured to receive and/or transmit data to/from a communications device in communication with the apparatus 102. In this regard, the communication interface 206 may include, for example, an antenna (or multiple antennae) and supporting hardware and/or software for enabling communications with a wireless communication network. Additionally, or alternatively, the communication interface 206 may include the circuitry for interacting with the antenna(s) to cause transmission of signals via the antenna(s) or to handle receipt of signals received via the antenna(s). In some environments, the communication interface 206 may alternatively or additionally support wired communication. As such, for example, the communication interface 206 may include a communication modem and/or other hardware and/or software for supporting communication via cable, digital subscriber line (DSL), universal serial bus (USB) or other mechanisms. In some embodiments, the communication interface 206 may enable communication with a cloud-based network to enable deep learning.

FIG. 2B illustrates a block diagram depicting communication of a map and positioning engine (MPE) 208 with the infotainment unit 110 of the EV 112, in accordance with one or more example embodiments. FIG. 2B is explained in conjunction with elements of FIG. 1 and FIG. 2A. The block diagram represents a map-enhanced Advanced Driver Assistance Systems (ADAS) architecture. The block diagram includes the MPE 208. The MPE 208 may further include a communication interface 210, a processor 212, a positioning system 214 and a data bus interface 216. The block diagram may further include the infotainment unit 110 that may communicate with a driver assistance application 218 or the driver assistance application 218 may be integrated with the infotainment unit 110 of an EV 112.

The MPE 208 may be a standalone module, however, it is understood that the MPE 208 may be distributed into multiple packages and/or integrated into other devices, such as a sensor package of a vehicle. The MPE 208 may also include other hardware, software, and/or firmware, such as memory and a power source.

In an embodiment, the processor 212 may be same as the processor 202. The processor 212 may be any type of processor, controller, or other computing device. For example, the processor 212 may be a digital signal processor. The processor 212 receives inputs from the positioning system 214, the communication interface 210, the data bus interface 216, and other sources such as a geographic database. For example, the geographic database may be the one or more databases 104A. In some embodiments, the one or more databases 104A may be a part of the MPE 208. The processor 212 then processes the inputs using one or more application software programs.

The processor 212 may then provide outputs to the driver assistance applications via the data bus interface 216 which may be an in-vehicle data bus interface and a data bus 220. Preferably, the data bus interface 216 and the data bus 220 may be a Controller-Area Network (CAN) interface and a CAN-bus, that may be designed for automotive applications. The driver assistance applications 218 may include navigation applications, adaptive headlight aiming, adaptive cruise control, obstruction detection, obstruction avoidance, collision avoidance, adaptive shift control, entertainment applications such as audio and video and so forth.

In some embodiments, the CAN bus is able to collect data from various car sensors and provide this data to the mapping platform 104 for further analysis and processing. The collected data includes things such as battery capacity of the vehicle in watt-hours (Wh), EV battery level in watt-hours (Wh), list of EV Connector Types the vehicle may use, EV charge port connected/EV charge port open, EV instantaneous charge rate in milliwatts, range remaining in meters, car details, manufacturer of vehicle, model of vehicle, model year of vehicle, and the like. This collected data may be transmitted by the communication interface 210 to the mapping platform 104.

In some embodiments, the communication interface 210 may be same as the communication interface 206 explained in FIG. 2A or the two interfaces may operate separately, and both conduct various forms of communication for the system 100.

The positioning system 214 may utilize Global Positioning System (GPS) or GNSS type technology, a dead reckoning-type system, or combinations of these or other systems, all of which are known in the art. The positioning system 214 may also include suitable sensing devices that may measure a traveling distance speed, direction, orientation, and so on. For example, the positioning system 214 may include a GPS system and a gyroscope. The positioning system 214 may provide an output signal to the processor 212. Some of the application software programs that run on the processor 212 use the output signal from the positioning system 214 to determine a location, direction, orientation, etc., of the MPE 208. The mapping platform 104 further processes the data for providing charging point recommendation for the EV 112.

FIG. 3 is a flow chart depicting steps of a method for providing charging point recommendation for an EV 112, in accordance with an example embodiment. FIG. 3 is explained in conjunction with elements of FIG. 1, FIG. 2A and FIG. 2B. It will be understood that each block/step of the diagram 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 204 of the apparatus 102, employing an embodiment of the present invention and executed by the processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flow diagram blocks.

Accordingly, the flow chart supports combinations of means for performing the specified functions and combinations of operations for performing the specified functions for performing the specified functions. It will also be understood that one or more blocks of the flow chart, and combinations of blocks in the flow diagram, may be implemented by special purpose hardware-based computer systems which perform the specified functions, or combinations of special purpose hardware and computer instructions. Fewer, more, or different steps may be provided.

At step 302, an input or indication regarding charging need may be received. In an embodiment, the processor 202 may be configured to receive input regarding the charging of the EV 112. The input regarding charging of the EV 112 may be received from the mobile device 108 associated with the user 108A of the EV 112. In another embodiment, the input regarding charging of the EV 112 may be received from the infotainment unit 110 of the EV 112. In another embodiment, apparatus 102 may be configured to determine a need to charge the EV 112 when a battery charge level of one or more batteries installed in the EV 112 is below a predetermined battery charge threshold. This information may be displayed to an end user via the vehicle's infotainment screen and/or a mobile device. This indication of charging need for the EV 112 may be used to generate a recommendation associated with one or more charging points 109 to charge the EV 112.

At step 306A, real-time charging data may be collected. In an embodiment, a processor 202 may be configured to collect the real-time charging data from the infotainment unit 110 of the EV 112. The real-time charging data may be collected from the infotainment unit 110 and the mobile device 118. In some embodiments, mobile device may be connected to the infotainment unit 110 and communicate information between the two via any functional data connection (USB, Bluetooth, etc). The collected real-time charging data may include at least charging information for the EV 112 and EV charge point 109 information. As discussed above, the EV charge point information may include information associated with one or more charging points that may be recommended by the apparatus 102. In an embodiment, the infotainment unit 110 may be configured to communicate with a controller area network (CAN) bus of the EV 112 to receive the real-time charging data for the EV 112. In an embodiment, an application may be installed on the infotainment unit 110 that may be configured to communicate with the CAN bus of the EV 112 and collect the real-time charging data from the CAN bus. The infotainment unit 110 may be configured to transmit the real-time charging data for the EV 112 to the processor 202. In an embodiment, the collected real-time charging data may further include, but is not limited to, a battery capacity of the EV 112 in watt-hours (Wh), a battery level of the EV 112 in watt-hours (Wh), the types of connectors used by the EV 112, whether the EV 112 charge port is connected or open, an instantaneous charge rate the EV 112 in milliwatts, a remaining driving range of the EV 112, and the like.

In another embodiment, it may be the case that data from the infotainment unit 110 or mobile device 108 is not available. For example, there may be a lack of network connectivity for one of these system devices. In such a case the real-time charging data may be collected from a mobile device 108 or infotainment device and communicated to the cloud, servers, etc. independently. With this in mind, the mobile device 108 may be associated with the user 108A of the EV 112 or the mobile device 108 may also be an additional mobile device associated with a passenger of a vehicle or a user of a different vehicle. The mobile device data may even be supplied by a device outside of any vehicle, meaning 2 crowdsourced from pedestrians, etc. Once such example could be collecting data on charge point locations and occupancy by pedestrians or bikers traveling in a given area.

The collected real-time charging data may include at least one of location information associated with the EV 112, a temperature at a current location of the EV 112, a battery capacity of the EV 112, a current battery level of the EV 112, connection information associated with at least one charging port of the EV 112, an instantaneous charge rate of the EV 112, a range for the EV 112 remaining at a current time given the battery charge, a current charging event associated with the location of the EV 112, and an occupancy information for the one or more charging points associated with the location of the EV 112.

At step 308, historical charging data may be retrieved. In an embodiment, the processor 202 may be configured to retrieve historical charging data associated with the EV 112. In an embodiment, the processor 202 may be configured to retrieve historical charging data associated with the EV 112 from the one or more databases 104A. The retrieved historical charging data may include, but are not limited to, compatible EV connector data, EV make or model data, EV model year or age data, or data associated with previous charging sessions of the EV 112. The historical data may also include data such as previous charging need predictions for similar EVs. The historical data might also include end user preferences. For example, if an end user wants to find the cheapest charging option, this information may be used to by the system to generate the charging need prediction. In such a situation, if there are multiple charge points 109 in the area, a prioritized list might be provided to the end user upon their mobile device 108 or infotainment system 110.

Other historical data might include EV connector data which may encompass various aspects and details about EV connectors such as, but not limited to, connector types and standards, connector compatibility, charging speeds, connector pinout, voltage and current ratings, connector design and physical specifications, safety features, regional variations, charging infrastructure data, and connector manufacturers.

EV make or model data may refer to: a make and model of the EV, a name of the manufacturer of the EV, a stock battery capacity of the EV, and the like. The EV model year or age data may also be used by the system. Data associated with previous charging sessions of an EV may refer to information and records related to one or more historical charging activities of an EV and may include, but is not limited to, a charging session timestamp, a charging duration, a charging station location, a charging connector information, an energy consumption, a charging power level, a charging cost, and the like.

In one embodiment, a processor 202 may be configured to generate a charging profile associated with an EV. The data included in this profile may include, but are not limited to the historical data listed above, previous charge information, EV battery health information, etc.

The charging profile may also include a set of parameters and characteristics on the charging behaviour of a given EV charges its one or more batteries over time. This means the charging profile may include information associated with a charging start time, a charging end time, a charging rate or power level, a battery state of charge (SOC) target, a charging mode, and the like. The charging profile may also hold data on the preferred charging strategy or schedule for an EV and may be customized or programmed by and end user or, in some cases, automatically managed by the vehicle's onboard systems in coordination with the presently disclosed system 100.

For example, if an end user typically only charges their battery to around 80% capacity and travels locally, then their charge needs might be predicted as less than an end user who typically charges to 100% every time and is on a long road trip.

The processor 202 may be further configured to store the generated charging profile associated in one or more databases 104A. In an embodiment, the processor 202 may be configured to utilize the stored charging profile to retrieve the historical charging data associated with an EV and update the charging profile in real-time as new charge data for a given EV is obtained.

At 310, the collected real-time charging data and the retrieved historical charging data may be provided as an input to the ML model 202F.

The ML model 202F may be one or more computational network or a system of artificial neurons, arranged in a plurality of layers, as nodes. The plurality of layers of the ML model may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the ML model. Outputs of each hidden layer may be coupled to inputs of at least one node in other layers of the ML model 202F. Node(s) in the final layer may receive inputs from at least one hidden layer to output a result. The number of layers and the number of nodes in each layer may be determined from hyper-parameters of the ML model. Such hyper-parameters may be set before or while training the ML model on a training dataset.

Each node of the ML model may correspond to a mathematical function (e.g., a sigmoid function or a rectified linear unit) with a set of parameters, tunable during training of the ML model. The set of parameters may include, for example, a weight parameter, a regularization parameter, and the like. Each node may use the mathematical function to compute an output based on one or more inputs from nodes in other layer(s) (e.g., previous layer(s)) of the ML model). All or some of the nodes of the ML model may correspond to same or a different mathematical function.

In training of the ML model, one or more parameters of each node of the ML model may be updated based on whether an output of the final layer for a given input (from the training dataset) matches a correct result based on a loss function for the ML model. The above process may be repeated for the same or a different input until a minima of loss function may be achieved, and a training error may be minimized. Several methods for training are known in art, for example, gradient descent, stochastic gradient descent, batch gradient descent, gradient boost, meta-heuristics, and the like.

In context of the present disclosure, the ML model 202F may be the trained on a historical training dataset that may be associated with an EV 112. Specifically, the historical training dataset may include the historical charging data associated with the EV and/or other EVs. As discussed above, the historical charging data may include compatible EV connector data, EV make or model data, EV model year or age data, or data associated with previous charging sessions of the EV. The data associated with the previous charging sessions of the EV may include, but is not limited to, at least one recommended charging point during each charging session, a waiting time for the charging the EV at the recommended charging point during each charging session, or a cost paid for each charging session, and the like. The ML model may learn patterns and knowledge from the historical training dataset to make predictions or decisions on new, incoming data. Details about the application of the ML model are provided below.

The ML model may include electronic data, such as, for example, a software program, code of the software program, libraries, applications, scripts, or other logic or instructions for execution by a processing device, such as circuitry. The ML model may include code and routines configured to enable a computing device, such as the apparatus 102 to perform one or more operations. Additionally, or alternatively, the ML model 202F may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 202F may be implemented using a combination of hardware and software.

The processor 202 may be configured to provide the collected charging data and the retrieved historical charging data, as an input, to the ML model. The ML model may be a pre-trained model that may be trained on the dataset containing stored or real-time charging data and the historical charging data to output the charging need prediction as discussed above.

At 312, a charging need prediction may be generated. In an embodiment, the processor 202 may be configured to generate the charging need prediction that may be associated with the EV 112. The charging need prediction may be generated based on the collected real-time charging data, the retrieved historical charging data, EV charge point information. The generated charging need prediction may also be associated with a charging profile of the EV. This profile may also be used at least in part to generate a charging need prediction. As mentioned above, the charging profile may be part of the historical data utilized by the system when generating a charging need prediction. The charging profile for a given EV may take into account end user preferences such as the cheapest charging point, closest charging point to a given POI (e.g., event or stadium) or POI Type (e.g., restaurants), etc.

In another embodiment, the processor 202 may be configured to generate the charging need prediction based on an output of the ML model 202F. As discussed above, the ML model may be a pre-trained model that may be trained on the historical training dataset to output the charging need prediction for an EV. The processor may be configured to apply the ML model to the collected real-time charging data and the retrieved historical charging data associated with an EV to determine the charging need prediction for the EV. The ML model may generate the charging need prediction by leveraging the learned patterns and knowledge from the historical training dataset associate with an EV.

In yet another embodiment, the system 100 may generate a charging need prediction for at least one additional EV with a similar charging profile as a first EV. The EV 112 shown in FIG. 1 for example, has its own unique characteristics. These characteristics may match or be similar to another EV with the same make or model, model year or age, etc. Additionally, many electric vehicles use the same types of batteries or feature similar historical charging data. Thus, the system 100 via processor 202 and memory 204 may be configured to generate an output based on the similarities in charging profile and/or historical charging data for at least one additional EV. The similarities between charging profiles, historical data, etc. may be generated by one or more machine learning models such as model 202F.

The charging need prediction generated may include, but is not limited to, information associated with at least one of an average charging speed of an EV, a maximum charging speed of an EV, a charging curve of a battery of an EV, a waiting time for charging at one or more charging points or set of charging points, an amount of time required for charging at the one or more charging points or set of charging points, and/or information about charging failures and compromised charging speed at the one or more charging points or set of charging points.

At step 314, an output may be generated. In an embodiment, the processor 202 and memory 204 may be configured to generate the output. The processor, memory, etc. may be configured to generate the output based on the generated charging need prediction. In an embodiment, the generated output may include at least one of a charging point recommendation, a predicted waiting time one or more charging points, and/or a monetary cost estimate for the one or more charging points.

In some embodiments, the generated output may correspond to a navigation route from a current location of an EV to the recommended one or more charging points. Furthermore, the generated output may include additional information associated with POIs such as, but not limited to, a restaurant, a hotel, a recreational area, rest area, and the like that may be near the recommended one or more charging points. In some embodiments, such information may be personalized for the user based on their preferences.

At 316, the generated output may be stored. In an embodiment, the processor 202 may be configured to store the generated output in any of the following: the memory 204, the cloud 106, databases 104A, server 104B, etc. The output data may also be sent to one or more other systems, applications, etc. for use in mapping, routing, civic planning, etc. The processor 202 may be further configured to utilize the output for controlling at least one of a vehicle navigation system, a vehicle control system, a vehicle electronic control unit, or an autonomous vehicle control system associated with an EV.

For example, when planning a road trip an end user might wish to plan a family friendly trip wherein the route their EV travels will make pre-planned charging stops along the route to their destination. The system 100 may determine the need for family friendly restaurants, etc. based on end user preferences or deduce as much from EV sensors and cameras. In this example, an EV may feature cameras, sensors, etc. which are able to identify the occupancy of the vehicle. If children are detected by the system, the suggested charging locations may be close to relevant POIs such as popular children's restaurants or attractions. Thus, the system 100 may provide automatic or manual routing to one or more charging locations based on input or perceived user preferences.

The vehicle navigation system may correspond to a technology that may be integrated into an EV that provides real-time guidance and an assistance for drivers to navigate their routes efficiently and accurately. Typically, the vehicle navigation system may include a GPS (Global Positioning System) technology and software that offers turn-by-turn directions, map displays, and often include features like traffic updates, points of interest, and voice guidance, enabling drivers to plan and follow routes, find destinations, and reach their destinations with greater convenience, safety, and precision.

The vehicle control system for an EV may correspond to an integrated electronic and software system that may be responsible for managing and regulating various aspects of one or more operations of an EV. The vehicle control system may encompass functions such as power distribution to the electric motors, battery management, regenerative braking control, thermal management, traction control, and overall vehicle performance optimization. It monitors critical parameters, adjusts power delivery, and ensures the efficient and safe operation of an EV, contributing to its performance, range, and reliability.

The vehicle electronic control unit (ECU) for the EV may be a specialized computerized component responsible for managing and coordinating the various electrical and electronic systems within the EV. The vehicle ECU may play a pivotal role in controlling functions such as motor drive, battery management, energy regeneration, thermal management, and overall vehicle performance optimization. The ECU may continuously process data from sensors throughout the vehicle, making real-time decisions to ensure efficient and safe operation, maximize energy utilization, and deliver a smooth and responsive driving experience in the context of an electric powertrain.

The autonomous vehicle control system associated with an EV may be an advanced and integrated set of hardware and software technologies that enable the EV to operate without human intervention. The autonomous vehicle control system may include various sensors, such as cameras, lidar, radar, and ultrasonic sensors, to perceive surroundings of an EV and detect obstacles, pedestrians, and road conditions. The control system may further process the sensor data, making real-time decisions on vehicle speed, steering, braking, and other driving tasks to navigate safely and efficiently. Further, it may also incorporate mapping and localization algorithms to determine the vehicle's precise position on the road. The combination of autonomous capabilities and an electric powertrain contributes to the development of environmentally friendly and self-driving transportation solutions. It should be noted that the example EV 112 shown in FIG. 1 may be representative of any electric vehicle including consumer cars, trucks, motorbikes, etc. as well as commercial vehicles, industrial vehicles, etc.

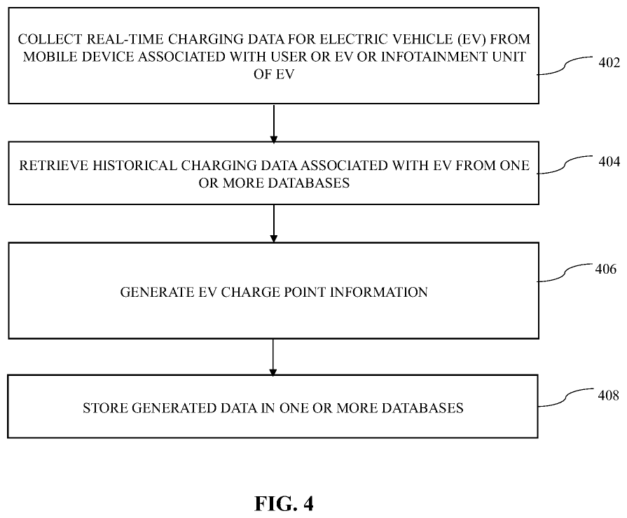

FIG. 4 is a flowchart that illustrates an exemplary method for charging point identification, in accordance with an embodiment of the disclosure. FIG. 4 is explained in conjunction with elements from FIG. 1, FIG. 2A, FIG. 2B, and FIG. 3. With reference to FIG. 4 the operations shown may be executed by any computing system, for example, by the apparatus 100 of FIG. 1 and its processor 202 of FIG. 2A.

At step 402, real-time charging data for the EV 112 may be collected. In an embodiment, the apparatus 102 may be configured to collect the real-time charging data for the EV 112 from the mobile device 108 associated with the user 108A of the EV 112 and/or an infotainment unit 110 of the EV 112. The collected real-time charging data includes charging information for the EV 112 and/or EV charge point information (see below).

At step 404, the apparatus 102 may be configured to retrieve historical charging data associated with the EV 112 from the one or more databases 104A.

In this embodiment, the system 100 and/or apparatus 102 may be configured to identify a location as a charging point and capture information about said point (step 406). Specifically, the apparatus 102 may be configured to identify a location, POI, etc. as a charging point based on amongst other things, an analysis of movement data of the mobile device 108 associated with the user 108A of the EV 112. Movement data of at least one additional mobile device, EV location data, CAN bus information, and one or more pre-stored charging locations may also be referenced to identify a charging location.

For example, the apparatus 102 may be configured to identify a location as a charging point based on the correlation of the location of the EV 112 with the one or more pre-stored charging locations and the time spent at said location. If the EV 112 stops at the location for a first-time period (say 45 minutes), then it may be deemed that such stop may correspond to a charging event for the EV 112. The location data may be correlated with the one or more pre-stored charging locations, such as in the one or more databases 104A of the mapping platform 104, to determine whether the EV 112 is stopped at the charge station, near it, or just merely stopped for some other non-charging event. If the system 100 determines a charge has taken place, statistics about the length of the charging event can be captured and may be stored within the charging profile for the EV 112. The apparatus 102 may further utilize the charging profile of the EV 112 to generate the charging need prediction for the EV 112 as discussed above.

Information regarding charge events/charge points detected by movement data of a mobile device may be confirmed from CAN bus data, data provided by charge point operators (when available), etc. This confirmation is optional depending on how the system 100 is configured.

The disclosed system 100 may be able to recommend one or more charging points to the user 108A of the EV 112 using the crowd-sourced data (e.g., charge point locations and their properties) and EV-specific data (e.g., charge curve). The ability to crowd source this charging data from multiple sources (like multiple EVs) lessens the dependence on the charging point operators for EV charging data.

At 408, the generated charge point information may be stored. In an embodiment, the apparatus 102 may be configured to store the generated information in the one or more databases 104A. In at least one embodiment, the processor 202 may be configured to store the generated charging need prediction in the one or more databases 104A, as described, for example, in FIG. 1 and FIG. 3 (at 314 and 316).

Accordingly, blocks of the flowchart of FIG. 4 support combinations of means for performing the specified functions and combinations of operations for performing the specified functions. It will also be understood that one or more blocks of the flowchart, and combinations of blocks in the flowchart, can be implemented by special-purpose hardware-based computer systems which perform the specified functions, or combinations of special-purpose hardware and computer instructions.

Alternatively, the system 100, apparatus 102, etc. may comprise means for performing each of the operations described above. In this regard, according to an example embodiment, examples of means for performing operations may comprise, for example, the processor 202 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An apparatus comprising at least one processor and at least one memory including computer program code, the at least one memory and computer program code configured to, with the processor, cause the apparatus to at least:
collect real-time charging data for an electric vehicle (EV) from a mobile device associated with a user of the EV or an infotainment unit of the EV, wherein the collected real-time charging data includes at least charging information for the EV and EV charge point information;
retrieve historical charging data associated with the EV from one or more databases;
generate a charging need prediction associated with the EV based on the collected real-time charging data, the retrieved historical charging data, and the EV charge point information, wherein the generated charging need prediction is associated with a charging profile of the EV; and
store the generated charging need prediction in the one or more databases.

2. The apparatus of claim 1, wherein the infotainment unit is configured to communicate with a controller area network (CAN) bus of the EV to receive the real-time charging data for the EV.

3. The apparatus of claim 1, wherein the collected real-time charging data comprises at least one of: location information associated with the EV, a temperature at a current location of the EV, a battery capacity of the EV, a current battery level of the EV, connection information associated with at least one charging port of the EV, an instantaneous charge rate of the EV, a range of the EV remaining at a current time instance, a current charging event associated with the location of the EV, and an occupancy information of a set of charging points associated with the location of the EV.

4. The apparatus of claim 1, wherein the at least one processor and the at least one memory including computer program code are configured to, with the processor, cause the apparatus to also:
identify a location as a charging point based on a comparison of movement data of the mobile device associated with a user of the EV, EV location data, and one or more pre-stored charging locations.

5. The apparatus of claim 1, wherein the at least one processor and the at least one memory including computer program code are configured to, with the processor, cause the apparatus to also:
generate a charging profile associated with the EV based on specification data associated with the EV;
store the generated charging profile in the one or more databases; and
utilize the stored charging profile to retrieve the historical charging data associated with the EV.

6. The apparatus of claim 1, wherein the historical charging data comprises at least one of: compatible EV connector data, EV make or model data, EV model year or age data, or data associated with previous charging sessions of the EV.

7. The apparatus of claim 1, wherein the at least one processor and the at least one memory including computer program code are configured to, with the processor, cause the apparatus to also generate an output based on the charging need prediction, wherein the output comprises at least one of: a charging point recommendation, a predicted waiting time for the EV at one or more charging points, or a cost estimate for the one or more charging points.

8. The apparatus of claim 7, wherein the output is utilized to control at least one of: a vehicle navigation system, a vehicle control system, a vehicle electronic control unit, or an autonomous vehicle control system associated with the EV.

9. The apparatus of claim 1, wherein the at least one processor and the at least one memory including computer program code are configured to, with the processor, cause the apparatus to also:
provide, as an input, the collected real-time charging data, and the retrieved historical charging data, to a machine learning (ML) model; and
receive, as an output from the ML model, the charging need prediction for the EV.

10. A method comprising:
collecting real-time charging data for an EV from a mobile device associated with a user of the EV or an infotainment unit of the EV, wherein the collected real-time charging data includes at least charging information for the EV and EV charge point information;
retrieving historical charging data associated with the EV from one or more databases;
generating a charging need prediction associated with the EV based on the collected real-time charging data, the retrieved historical charging data, and the EV charge point information, wherein the generated charging need prediction is associated with a charging profile of the EV; and
storing the generated charging need prediction in the one or more databases.

11. The method of claim 10, wherein the infotainment unit is configured to communicate with a controller area network (CAN) bus of the EV to receive the real-time charging data for the EV.

12. The method of claim 10, wherein the collected real-time charging data comprises at least one of: location information associated with the EV, a temperature at a current location of the EV, a battery capacity of the EV, a current battery level of the EV, connection information associated with at least one charging port of the EV, an instantaneous charge rate of the EV, a range of the EV remaining at a current time instance, a current charging event associated with the location of the EV, and an occupancy information of a set of charging points associated with the location of the EV.

13. The method of claim 10, further comprising:
identifying a location as a charging point based on a comparison of movement data of at least one additional mobile device, EV location data, and one or more pre-stored charging locations.

14. The method of claim 10, further comprising:
generating a charging profile associated with the EV based on specification data associated with the EV;
storing the generated charging profile in the one or more databases; and
utilizing the stored charging profile to retrieve the historical charging data associated with the EV.

15. The method of claim 10, wherein the historical charging data comprises at least one of: compatible EV connector data, EV make or model data, EV model year or age data, or data associated with previous charging sessions of the EV.

16. The method of claim 10, further comprising generating an output based on the charging need prediction, wherein the output comprises at least one of: a charging point recommendation, a predicted waiting time for the EV at one or more charging points, or a cost estimate for the one or more charging points.

17. The method of claim 16, wherein the output is utilized for control of at least one of:
a vehicle navigation system, a vehicle control system, a vehicle electronic control unit, or an autonomous vehicle control system associated with the EV.

18. The method of claim 10, further comprising:
providing, as an input, the collected real-time charging data, and the retrieved historical charging data, to a machine learning (ML) model; and
receiving, as an output from the ML model, the charging need prediction for the EV.

19. The method of claim 18, wherein the output from the ML model is a charging need prediction for at least one additional EV, wherein the at least one additional EV has a similar charging profile.

20. The method of claim 19, wherein the at least one additional EV with similar charging profile includes a similar EV make or model, a similar model year or age, or similar historical charging data.
